(19) United States
(12) Patent Application Publication
(10) Pub. No.: US 2018/0364072 A1
(43) Pub. Date: Dec. 20, 2018

(54) POSITION DETECTION DEVICE FOR A GEAR LEVER AND GEAR SELECTION LEVER

(71) Applicant: ZF Friedrichshafen AG, Friedrichshafen (DE)

(72) Inventors: Alexander Kirilenko, Diepholz (DE); Joachim Spratte, Osnabrueck (DE)

(73) Assignee: ZF Friedrichshafen AG, Friedrichshafen (DE)

(21) Appl. No.: 16/060,217

(22) PCT Filed: Nov. 8, 2016
(86) PCT No.: PCT/EP2016/076901

§ 371 Date: Jun. 7, 2018

(30) Foreign Application Priority Data
Dec. 10, 2015 (DE) 10 2015 224 906.9

(51) Int. Cl. G01D 5/34; F16H 59/10; F16H 59/04

(52) U.S. Cl. CPC G01D 5/342; F16H 59/044; F16H 59/105

(57) ABSTRACT

The present invention relates to a position detecting apparatus for a shift lever of a motor vehicle, the position detecting apparatus having a light path, which comprises a light source, a light conductor and a light sensor, wherein the light path is configured to conduct light from the light source to the light sensor, depending on a position of the shift lever.

### BACKGROUND

The present invention relates to a position detecting apparatus for a shift lever of a motor vehicle and it relates to a gear selection apparatus.

For a gear lever of a motor vehicle, position detection can be performed using Hall sensors, which detect a magnetic field of a permanent magnet of the shift lever.

### BRIEF SUMMARY

Against this background, the present invention provides an improved position detecting apparatus for a shift lever and an improved gear selection apparatus for a motor vehicle in accordance with the main claims. Advantageous embodiments are included in the sub-claims and the following description.

We introduce a position detecting apparatus for a shift lever of a motor vehicle, the position detecting apparatus having a light path, which comprises a light source, a light conductor and a light sensor, wherein the light path is configured to conduct light from the light source to the light sensor, depending on a position of the shift lever.

A shift lever can involve a selector lever for selecting a transmission stage of a vehicle transmission. A light source, for example, can comprise a light-emitting diode. A light sensor, for example, can comprise a photo transistor. A light conductor can basically be transparent. Coupled light can be guided in the light conductor through total reflection within the light conductor. Light can be decoupled from the light conductor through a matt-finished surface. By changing the position of the shift lever, the light path can have an optical change.

In the approach described here, light, especially infrared light, is used to detect the position of the shift lever. In confined spaces, the light can show large fluctuations in intensity, whereby a clear demarcation between individual positions can be achieved. Advantageously, an optical position detection can be executed without contact. A light-based position detection has advantages compared to Hall sensors, which reproduce the strength of a magnetic field in an electrical signal. Because the magnetic field is depending on a distance to the permanent magnet, the signal shows a gradual course. Therefore, to detect a position, a limit value distinction is made. This is not required in light-based position detection.

The light conductor can be arranged in movable fashion relative to the light source and light sensor. In this way, the light conductor can perform a movement relative to the light source and light sensor in response to a movement of the shift lever. Generally speaking, at least one of the elements of the light path can be arranged in movable fashion relative to the other two elements of the light path. At least one of the elements of the light path can be coupled with the shift lever, so that the relative movement occurs when the shift lever is moved.

The position detecting apparatus can have at least one additional light path comprising a light source, the light conductor and a light sensor, the additional light path being configured to conduct light from the light source to the light sensor, depending on the position of the shift lever. The electrical signals of the light paths can have signal patterns that can be clearly associated with one position, respectively. The position can be clearly assigned by means of a second light path.

The additional light path can comprise the same light source or the same light sensor as the original light path. Multiple use can reduce system complexity of the position detecting device.

The light conductor can be arranged between the light source and the light sensor. The light conductor can be mechanically coupled with the shift lever. As a result, electrical components of the position sensing apparatus are fixed in the housing. Thus, flexible electrical connections can be omitted.

In the area of the light path, the light conductor can have a first transmission area with a first transmission characteristic and at least a second transmission area with a second transmission characteristic. In a first position of the shift lever, the first transmission area can be arranged between the light source and the light sensor. In a second position of the shift lever, the second transmission area can be arranged between the light source and the light sensor. For example, by means of different optical characteristics, light can strike the light sensor with a high intensity in the first position, while in the second position light strikes the light sensor with a low intensity. This allows for a clear distinction of the positions.

In the area of the light path, the light conductor can have a third transmission area with the first transmission characteristic and a fourth transmission area with the second transmission characteristic. In a third position of the shift lever, the third transmission area can be arranged between the light source and the light sensor. In a fourth position of the shift lever, the fourth transmission area can be arranged between the light source and the light sensor. A plurality of signal patterns can be distinguished using multiple transmission ranges.

The first transmission area, the second transmission area, the third transmission area, and the fourth transmission area can be arranged in quadrangular form. With the use of a quadrangular form, it is possible to detect two movement axes of the shift lever.

In the area of the light path, the light conductor can have at least one further transmission area with a further transmission characteristic. In a further position of the shift lever, the further transmission area can be arranged between the light source and the light sensor. The further transmission area can be arranged between the first transmission area and the second transmission area. With the use of three different optical characteristics, it is possible to detect reliably at least three positions per light path.

The transmission areas can be arranged on the light conductor in the form of a matrix. A plurality of positions can be detected using a matrix form in lines and columns.

An apparatus can involve an electrical device, which processes electrical signals, for example sensor signals, and on this basis outputs control signals. The apparatus can have one or multiple appropriate interfaces, which can be configured in the form of hardware and/or software. For example, when configured in the form of hardware, the interfaces can be part of an integrated circuit, in which functions of the apparatus are implemented. The interfaces can also involve custom integrated circuits or comprise at least in part discrete components. When configured in the form of software, the interfaces can involve software modules, which are located, for example, on a microcontroller besides other software modules.

According to one embodiment, a gear selection apparatus of a motor vehicle comprises a shift lever and a position detecting apparatus coupled with the shift lever. With the us of the position detecting apparatus, it is possible to detect a position of the shift lever.

### BRIEF DESCRIPTION OF THE DRAWINGS

By means of the enclosed drawings, the invention is described in more detail in an exemplary manner. It is shown:

FIG. 1 shows a representation of a selector lever with a position detecting apparatus according to an embodiment of the present invention;

FIG. 2 shows a representation of a light conductor mechanically coupled with a selector lever according to an embodiment of the present invention;

FIG. 3 shows a representation of an electrical circuit according to an embodiment of the present invention;

FIG. 4 shows a representation of a position detecting apparatus according to an embodiment of the present invention; and

FIG. 5 shows a matrix representation of different detectable positions according to an embodiment of the present invention.

### DETAILED DESCRIPTION OF THE DRAWINGS AND THE PRESENTLY PREFERRED EMBODIMENTS

In the following description of preferred embodiments of the present invention, the same or similar reference numerals are used for similar acting elements shown in the different figures, thus refraining from a repeated description of these elements.

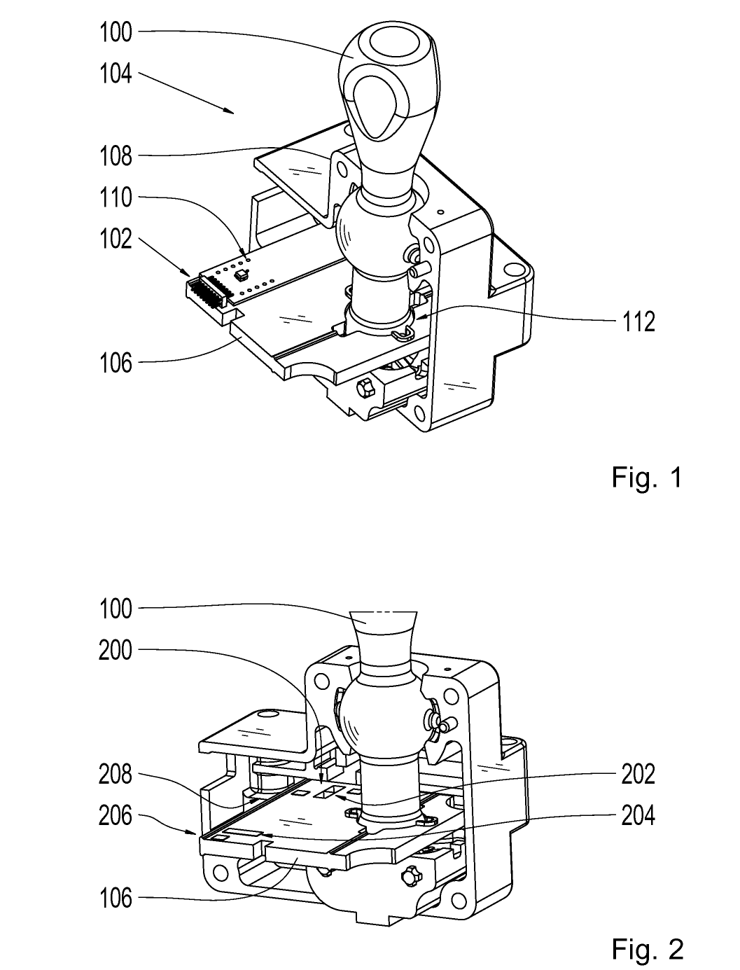

FIG. 1 shows a representation of a selector lever 100 with a position detecting apparatus 102 according to an embodiment of the present invention. The selector lever 100 is part of a gear selection apparatus 104 for a motor vehicle. Via a ball joint in two axles, the selector lever 100 is flexibly mounted in the gear selection apparatus 104. The position detecting apparatus 102 is part of the gear selection apparatus 104. The position detecting apparatus 102 is configured to reproduce the movement of the selector lever 100 in an electrical signal. For this purpose, the position detecting apparatus 102 comprises a light path 102, which leads from a light source through a light conductor 106 to a light sensor. The light source and the light sensor are arranged in movable fashion relative to the light conductor 106. In the embodiment shown, the light conductor 106 is flexibly mounted in the two axes in a housing 108 of the gear selection apparatus 104. The light conductor 106 is mechanically coupled with the selector lever 100, so that the movement of the selector lever 100 is transferred to the light conductor 106. The light source and the light sensor are part of an electrical circuit 110, which is connected with the housing 108 of the gear selection apparatus 104.

Here, the light conductor 106 is configured in the form of a transparent, plate-like component consisting of a plastic material, for example, polymethylmethacrylate (PMMA), which has an opening 112 to receive the selector lever 100. The light conductor 106 has a visual coding, which is configured to conduct light from the light source to the light sensor, depending on a position of the light conductor 106 relative to the electrical circuit 110.

In other words, the light conductor 106 has position-dependent transmission characteristics. As a result, the light sensor receives a position-dependent light intensity. The light intensity is detected and thus reproduces the position of the light conductor 106, as well as the position of the selector lever 100 coupled with the light conductor 106.

FIG. 2 shows a representation of a light conductor 106, which is mechanically coupled with a selector lever 100 according to an embodiment of the present invention. In essence, the selector lever 100 and the light conductor 106 correspond to the components shown in FIG. 1. In contrast to FIG. 1, the electrical circuit is not shown here, so as not to cover the light conductor 106. On a surface, the light conductor 106 comprises areas 200, 202, 204, which have different transmission characteristics. For example, the areas 200, 202, 204 have different light transmission, a different refractive index and/or a different structure. Depending on the position of the light conductor 106, the areas 200, 202, 204 are arranged in the light path.

In the first area 200, the light conductor 106 is brightly polished. In the second area 202, the light conductor 106 has a cutout or an opening. In the third area 204, the light conductor 106 has a rough surface or an erosion structure.

In one embodiment, the areas 200, 202, 204 are arranged in two groups 206, 208. The first group 206 is arranged in a first light path. The second group 208 is arranged in a second light path. The areas 200, 202, 204 are arranged differently in the groups 206, 208. As a result, there is a different transmission of light by means of the light conductor 106 in the first light path and the second light path, with the light conductor 106 being in the same position.

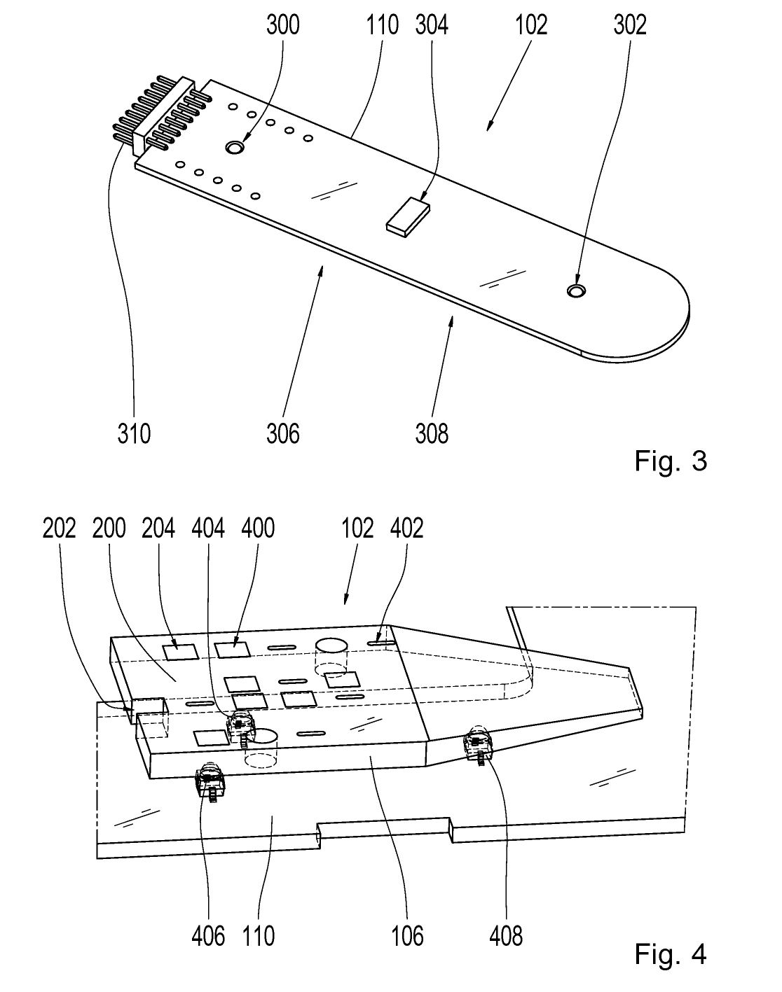

FIG. 3 shows a representation of an electrical circuit 110 of a position detecting apparatus 102 according to an embodiment of the present invention. The electrical circuit 110 corresponds to the electrical circuit shown in FIG. 1. Here, the electrical circuit comprises a first light source 300, a second light source 302 and a light sensor 304. At the same time, the first light source 300 and the light sensor 304 are associated with a first light path 306. The second light source 302 and the light sensor 304 are associated with a second light path 308. Thus, the light paths 306, 308 have different light sources 300, 302 and a mutual light sensor 304. Here, the light sources are configured in the form of infrared LEDs.

In one embodiment, the electrical circuit 110 comprises a first light source 300, a first light sensor 302 and a second light sensor. The first light source and the first light sensor are associated with the first light path 306. The second light source 302 and the first light sensor are associated with the first light path 308.

The electrical circuit 110 has a multi-pole interface 310. The interface 310 has a plurality of pins, which provide electrical signals for further processing.

Subsequently, using FIGS. 1 to 3, we present an embodiment of an opto-electrical switching position detection by means of infrared.

In current gearshift systems, the engaged switching positions, such as P, R, N, D, are detected by a permanent magnet and multiple Hall sensors as magnetic position sensors.

As the Hall sensors are highly susceptible to tolerance or have a narrow tolerance field, problems to detect a clearly exact switching position may occur with larger tolerance chains. Moreover, due to soft magnetic transitions only a low resolution can be attained.

According to an embodiment presented here, a detection of the individual switching positions is performed by means of infrared light. Compared to visible light, this has the advantage that the sensor 304 is less susceptible to stray light, which could enter the circuit 108 from the outside.

Two infrared-emitting diodes (IRED infrared emitting diode) 300, 302 and one infrared (IR) sensor 304 are used for sensing different switching positions. The diodes 300, 302 are operated with different pulses, so that the sensor 304 received two different signals. As shown in FIG. 3, the diodes 300, 302 and the sensor 304 can be positioned on the circuit board.

The signals of the diodes 300, 302 can be conducted to the sensor 304 by means of a light conductor 106. At said light conductor 106 areas 200, 202, 204 can be applied through which infrared light is reflected to the sensor 304 in a variety of ways. For example, the light conductor 106 has three different reflection geometries 200, 202, 204 for reflecting the light. For example, the light conductor has a polished (shiny) surface 200. At specific areas 204, it is possible, for example, to apply an erosion structure and in addition, openings 202 can be integrated. Depending on the arrangement of the reflection geometries 200, 202, 204 in relation to the diodes 300, 302, 2̂3 different signals can be detected, which can be associated with specific switching positions.

For six switching positions, multiple variations for positioning the reflection geometries 200, 202, 204 are listed in an exemplary manner. These reflection geometries 200, 202, 204 can be arranged in a variety of ways. It is also possible to apply reflection geometries 200, 202, 204 deviating from these at the light conductor 106.

Alternatively, or in addition, desired air inclusions or lasers can be integrated directly into the light conductor volume as reflection geometries 200, 202, 204 in the light conductor 106. As a result, the light can be controlled more precisely or completely blocked in certain areas.

According to one embodiment, prisms or optically effective elements are formed at the light conductor 106, which can also control the light in a precise manner. This can save expenses, because it is possible to implement various contours directly in a tool.

FIG. 4 shows a representation of a position detecting apparatus 102 according to an embodiment of the present invention. The position detecting apparatus 102 corresponds to the position detecting apparatus 102 shown in FIG. 1. In contrast to the light conductor shown in FIG. 2, the light conductor 106 shown here comprises five areas 200, 202, 204, 400, 402 with different transmission characteristics. The areas 200, 202, 204 with the shiny surface, the recess and the finely roughened surface correspond to the areas in FIG. 2. In the area 400, the surface is roughly structured by an erosion structure. In area 402, it is high-gloss polished or mirrored. Areas 200, 202, 204, 400, 402 are grouped in matrices. At the same time, the different areas 200, 202, 204, 400, 402 can be present multiple times in a row and/or column.

In contrast to FIG. 3, here the electrical circuit 110 comprises a first light sensor 404, a second light sensor 406 and a mutual light source 408. The light source 408 and the first light sensor 404 are associated with the first light path. The light source 408 and the second light sensor 406 are associated with the second light path.

Here, the light conductor 106 is arranged parallel spaced to a circuit board of the electrical circuit 110. The light sensors 404, 406 are arranged in such a way that a characteristic light image is obtained per relative position of the light conductor 106 to the electrical circuit 110. The light image received is evaluated in the electrical circuit 110 and compared with stored light images. By means of the comparison, the light image received is associated with the relative position, and the relative position is reproduced in a position signal.

It is also possible to apply different erosion structures to generate more signals. The difference between a finer and slightly larger erosion structure, in relation to the reflection of the light, results in changing the received signal.

In one embodiment, one diode 408 and, for example, two or more diodes 404, 406 or transistors 404, 406, can be used as receivers. By means of the diode 408, the light is permanently coupled in the light conductor 106 and, as before, uncoupled at certain areas 200, 202, 204, 400, 402 by eroding structures and/or recesses above the receivers 404, 406 to be able to detect different switching positions. By using two receivers 404, 406, it is possible to dispense differently pulsed diodes 408, which makes the construction easier.

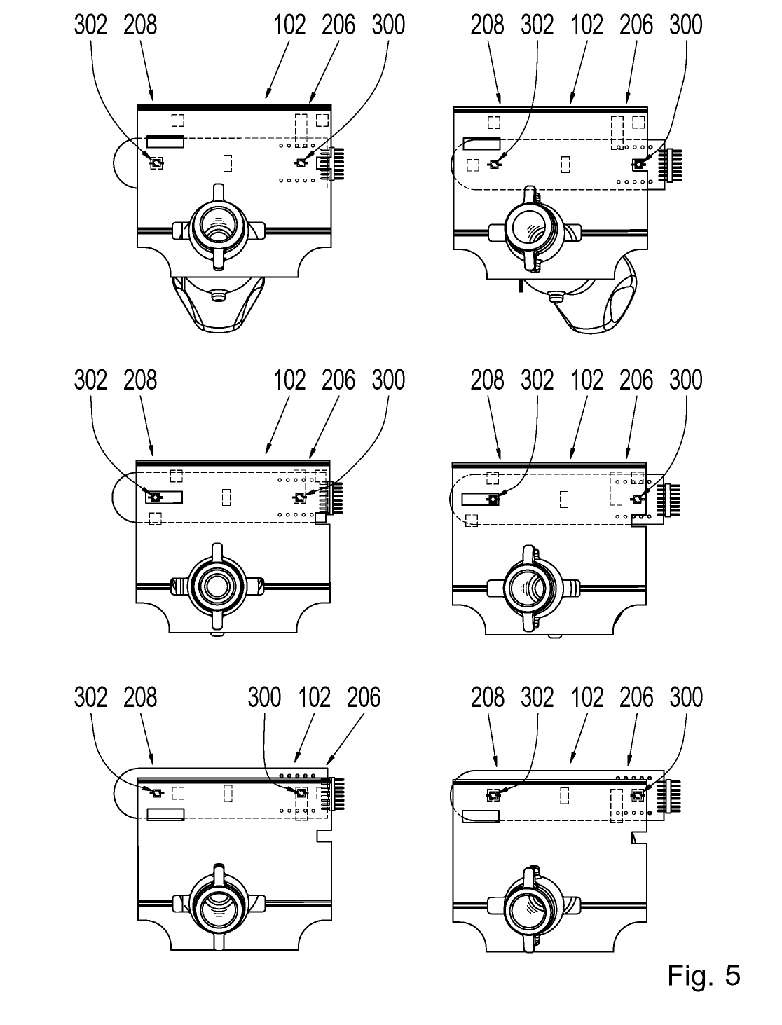

FIG. 5 shows a matrix representation of different detectable positions according to an embodiment of the present invention. The different positions are shown by means of the position detecting apparatus represented in FIGS. 1 and 2. The position detecting apparatus 102 is configured to resolve six different positions of the selector lever. At the same time, the first light source 300 is associated with the first group 206. The second light source 302 is associated with the second group 208.

In a first position of the selector lever, the selector lever is in a basic position. The selector lever is deflected neither in the first axis nor in the second axis. As a result, the light conductor mechanically coupled with the selector lever is also deflected neither in the first axis nor in the second axis. In the first position, a roughened area of the first group 206 is arranged in front of the first light source 300. A section of the second group 208 is arranged in front of the second light source 302.

In a second position, the selector lever is deflected in the first axis in one direction and not deflected in the second axis. At the same time, a shiny area of the first group 206 is arranged in front of the first light source 300, and a roughened area of the second group 208 is arranged in front of the second light source 302. In a third position, the selector lever is deflected in an opposite direction in the first axis and not deflected in the second axis. At the same time, the roughened area of the first group 206 is arranged in front of the first light source 300, and a shiny area of the second group 208 is arranged in front of the second light source 302.

In a fourth position, the selector lever is not deflected in the first axis and laterally deflected in the second axis. At the same time, a shiny area of the first group 206 is arranged in front of the first light source 300, and the section of the second group 208 is arranged in front of the second light source 302.

In a fifth position, the selector lever is deflected in the direction in the first axis and laterally deflected in the second axis. At the same time, a section of the first group 206 is arranged in front of the first light source 300, and a shiny area of the second group 208 is arranged in front of the second light source 302.

In a sixth position, the selector lever is deflected in the first axis in the opposite direction and laterally deflected in the second axis. At the same time, a roughened area is arranged, respectively, in front of the first light source 300 and in front of the second light source 302.

When an embodiment comprises an “and/or” connection between a first characteristic and a second characteristic, it can mean that in one configuration the embodiment comprises the first characteristic, as well as the second characteristic, and according to a further configuration, the embodiment comprises only the first characteristic or only the second characteristic.

100 selector lever

102 position detecting apparatus

104 gear selection apparatus

106 light conductor

108 housing

110 electrical circuit

112 opening

200 first area

202 second area

204 third area

206 first group

208 second group

300 first light source

302 second light source

304 light sensor

306 first light path

308 second light path

310 interface

400 fourth area

402 fifth area

404 first light sensor

406 second light sensor

408 light source

1. A position detecting apparatus for a shift lever of a motor vehicle, the position detecting apparatus comprising:
a light path comprising a light source, a light conductor and a light sensor, wherein the light path is configured to conduct light from the light source to the light sensor, depending on a position of the shift lever.

2. The position detecting apparatus of claim 1, wherein the light conductor is arranged in movable fashion relative to the light source and light sensor.

3. The position detecting apparatus of claim 1 further comprising a second light path comprising a second light source, the light conductor and a second light sensor, the second light path being configured to conduct light from the second light source to the light sensor, depending on the position of the shift lever.

4. The position detecting apparatus of claim 3, wherein the second light source of the second light path is the same as the light source of the light path or the second light sensor of the second light path is the same as the light sensor of the light path.

5. The position detecting apparatus of claim 1, wherein the light conductor is arranged between the light source and the light sensor and mechanically coupled with the shift lever.

6. The position detecting apparatus of claim 1, wherein the light conductor has in the area of the light path a first transmission area with a first transmission characteristic and at least a second transmission area with a second transmission characteristic, wherein in a first position of the shift lever, the first transmission area is arranged between the light source and the light sensor, and in a second position of the shift lever, the second transmission area is arranged between the light source and the light sensor.

7. The position detecting apparatus of claim 6, wherein in the area of the light path the light conductor has a third transmission area with the first transmission characteristic and a fourth transmission area with the second transmission characteristic, wherein in a third position of the shift lever, the third transmission area is arranged between the light source and the light sensor, and in a fourth position of the shift lever, the fourth transmission area is arranged between the light source and the light sensor.

8. The position detecting apparatus of claim 7, wherein the first transmission area, the second transmission area, the third transmission area and the fourth transmission area are arranged in quadrangular form.

9. The position detecting apparatus of claim 7, wherein in the area of the light path the light conductor has at least one further transmission area with a further transmission characteristic, wherein in a further position of the shift lever, the further transmission area is arranged between the light source and the light sensor.

10. The position detecting apparatus of claim 9, wherein the further transmission area is arranged between the first transmission area and the second transmission area.

11. The position detecting apparatus of claim the first, second, third and fourth transmission areas are arranged on the light conductor in the form of a matrix.

12. A gear selection apparatus for a motor vehicle, the gear selection apparatus comprising:
a shift lever; and
a position detecting apparatus coupled with the shift lever, the position detecting apparatus comprising a light path comprising a light source, a light conductor, and a light sensor, wherein the light patent is configured to conduct light from the light source to the light sensor depending on a position of the shift lever.

13. The position detecting apparatus of claim 2 further comprising a second light path comprising a second light source, the light conductor and a second light sensor, the second light path being configured to conduct light from the second light source to the light sensor, depending on the position of the shift lever.

14. The position detecting apparatus of claim 13, wherein the second light source of the second light path is the same as the light source of the light path or the second light sensor of the second light path is the same as the light sensor of the light path.

15. The position detecting apparatus of claim 2, wherein the light conductor is arranged between the light source and the light sensor and mechanically coupled with the shift lever.

16. The position detecting apparatus of claim 2, wherein the light conductor has in the area of the light path a first transmission area with a first transmission characteristic and at least a second transmission area with a second transmission characteristic, wherein in a first position of the shift lever, the first transmission area is arranged between the light source and the light sensor, and in a second position of the shift lever, the second transmission area is arranged between the light source and the light sensor.

17. The position detecting apparatus of claim 16, wherein in the area of the light path the light conductor has a third transmission area with the first transmission characteristic and a fourth transmission area with the second transmission characteristic, wherein in a third position of the shift lever, the third transmission area s arranged between the light source and the light sensor, and in a fourth position of the shift lever, the fourth transmission area is arranged between the light source and the light sensor.

18. The position detecting apparatus of claim 17, wherein the first transmission area, the second transmission area, the third transmission area and the fourth transmission area are arranged in quadrangular form.

19. The position detecting apparatus of claim 8, wherein in the area of the light path the light conductor has at least one further transmission area with a further transmission characteristic, wherein in a further position of the shift lever, the further transmission area is arranged between the light source and the light sensor.

20. The position detecting apparatus of claim 17, wherein the further transmission area is arranged between the first transmission area and the second transmission area.
